(19) United States
(12) Patent Application Publication
(10) Pub. No.: US 2015/0006394 A1
(43) Pub. Date: Jan. 1, 2015

(54) TRANSACTION METHOD AND SYSTEM

(71) Applicant: MSPay ApS, Arhus C (DK)

(72) Inventors: Mads Siim, Brabrand (DK); Sonny Leach, Hammel (DK)

(21) Appl. No.: 14/318,389

(22) Filed: Jun. 27, 2014

Related U.S. Application Data
(62) Division of application No. 13/504,426, filed on Nov. 13, 2012.
Application No. 13/504,426 is a continuation-in-part of application No. PCT/DK2010/000001, filed on Jan. 4, 2010.

(30) Foreign Application Priority Data
Oct. 28, 2009 (DK) PA 2009 01158

(51) Int. Cl. G06Q 20/40; G06Q 20/10

(52) U.S. Cl. CPC G06Q 20/40; G06Q 20/10
USPC 705/44

(57) ABSTRACT

The present invention relates to a method of authenticating identity of an individual, the individual having a portable electronic device including identification information and a portable electronic device communication device, the portable electronic device adapted to communicate with an authentication device comprising identification information relating to authorised individuals. The method includes: the authentication device generating an identification request for identification of the individual, the portable device requesting reception of the identification request from the authentication device, transmitting the identification request from the authentication device to the portable device, generating an identification response and transmitting the identification response from the portable device to the authentication device, the authentication device receiving the identification response and relating the identification information in the identification response to the identification information relating to authorised individuals, establishing if the user is an authorised individual, provided the user is an authorised individual performing a related action.

### CROSS REFERENCE TO RELATED APPLICATIONS

This application is a divisional of and claims the benefit and priority to U.S. patent application Ser. No. 13/504,426, filed on Nov. 13, 2012, which is a U.S. National Phase application of PCT International Application Number PCT/DK2010/050288, filed on Oct. 28, 2010, designating the United States of America and published in the English language, which is an International Application of and claims the benefit of priority to United Danish Patent Application No. PA 2009 01158, filed on Oct. 28, 2009, and PCT International Application No. PCT/DK2010/050288 is a continuation in part of and claims the benefit of priority to PCT/DK2010/000001, filed on Jan. 4, 2010. The disclosures of the above-referenced applications are hereby expressly incorporated by reference in their entireties.

### FIELD OF THE INVENTION

Generally the present invention relates to a method of performing a transaction, a method of authenticating identity of an individual and a transaction system. The present invention relates to a method for processing payment transactions between a buyer and a seller via an electronic transaction arrangement as well as to a transaction unit for use with such method.

### BACKGROUND OF THE INVENTION

Electronic payment transaction has been known for many years by means of credit card terminal etc. and by providing credit card information or other payment identification information to the seller, e.g. by entering the data in a secured manner on a homepage belonging to the seller after accessing the homepage via a public data communication network such as by means of an internet protocol.

A general problem is to provide an effective and user-friendly manner of processing such payment transactions and at the same time provide a high level of data security with respect to the payment identification information, e.g. the credit card number so as to prevent misuse of such data. It is an object of the present invention to improve known techniques for this purpose.

When using an apparatus to perform an action requiring identification of the person using an apparatus it is important to have some sort of method for establishing or verifying the identity of that person. Such actions include financial transactions, e.g. purchase of goods, where funds are to be transferred from one account to another. Other situations where such a method or system is advantageous include elections and other voting setups. If a person should provide false information one or more persons or companies suffer a financial loss. Hence, an improved system and method for establishing identity of a person would be advantageous.

### OBJECT OF THE INVENTION

It is an object of the present invention to provide a system that establishes identity of a person

It is a further object of the present invention to provide an alternative to the prior art.

The present invention relates to a method for processing a payment transaction between a buyer and a seller by means of a transaction arrangement including a transaction processing unit, an electronic seller's unit connected to the transaction processing unit via a data communication network, and an electronic buyer's unit connected to the transaction processing unit via a data communication network, the method comprising the steps of:

Receiving a payment request from the electronic seller's unit to the transaction processing unit, the payment request comprising at least seller identification data and buyer identification data,

preparing a payment verification request based on said payment request by means of the transaction processing unit,

forwarding the payment verification request from the transaction processing unit to the electronic buyer's unit,

receiving a payment verification from the electronic buyer's unit to the transaction processing unit, and

approving the payment transaction when said payment request as well as said payment verification corresponding thereto have been received by the transaction processing unit.

By use of such two-factor payment transaction processing, the possibility of an intruder to intercept the communication and mimic the communication in order to have a false payment request approved is minimized.

It is particularly preferred that the payment request comprises first buyer identification data and the payment verification comprises second buyer identification data being different from the first buyer identification data, and wherein approvement of the payment transaction further requires that it has been confirmed that the first buyer identification data are correctly correlated with the second buyer identification data.

The first buyer identification data is a specific set of data identifying the buyer to the transaction processing unit, such as e.g. a credit card number, a cell phone number e.g. in combination with a four digit personal code, a social security number etc. The first buyer identification data are communicated from the buyer to the seller's unit, e.g. by accessing a home page of the seller from a computer via a public data communication network, such as the Internet, where the buyer enters the first buyer identification data, so that the seller's unit is enabled to include the first buyer identification data together with the seller identification data and possibly other data, such as a payment amount and data identifying the purchase in the payment request which is forwarded to the transaction processing unit. Alternatively, the first buyer identification data may be transmitted orally by the user, by means of telephone communication or by near-field communication, such as by means of an RFID, Bluetooth or the like which may be integrated in the buyer's unit.

The second buyer identification data is provided from the buyer's unit. It may in a very simple version, where the buyer's unit is a personal mobile telephone, be a code identifying the telephone itself. More advanced and safe identification systems may also be applied of which many are well known in the art. In case encrypted communication is performed between the buyer's unit and the transaction processing unit, the ability of the buyer's unit to perform the correct encryption and/or decryption may be sufficient to prove the buyer's identity to the transaction processing unit and thus constitute second buyer identification data as this term is understood herein.

In order to accept and process a payment transaction, the first buyer identification data as well as the corresponding second buyer identification data must be presented to the transaction processing unit. These two set of identification data are communicated separately between the seller's unit and the buyer's unit, respectively, and the transaction processing unit, and the security of the system is therefore very high as a possible misuse of the system would require that both the first and the second buyer identification data are obtained, i.e. that communication between the seller's unit and the transaction processing unit as well as the buyer's unit and the transaction processing unit are successfully intercepted and that the correct buyer identification data are matched, i.e. that a payment request and a payment verification referring to the same buyer are identified.

The transaction processing unit forwards preferably the payment verification request to a specific electronic buyer's unit corresponding to the first buyer identification data, such as a mobile telephone or a computer. Alternatively, user utilises a buyer's unit physically arranged in a public place or even at the seller's shop and identifies him or herself e.g. by means of a chip card.

The method may advantageously further comprise the step of forwarding a enquiry for payment verification requests from the electronic buyer's unit to the transaction processing unit, which in response to receiving this enquiry forwards said payment verification request to the electronic buyer's unit. Hereby, the payment verification requests are not pushed to the buyer's unit from the transaction processing unit, which reduces the risk of the user to verify payment verification requests that are generated erroneously.

In particular the present method is suitable for E-commerce and the method may therefore comprise the step of
establishing a data communication connection between a computer system and the seller's unit, and
forwarding the buyer identification data for being applied in the payment request to the seller's unit.

Furthermore, the transaction processing unit may be constructed to comprise a front-end part which via the data transmission networks is connected to the electronic seller's unit and to the electronic buyer's unit, and a back end part which via a data transmission network is connected to external providers of financial transaction, the method comprising the steps of
preparing a financial transaction request in response to the approvement of the payment transaction by means of the front-end part of the transaction processing unit,
forwarding a enquiry for financial transaction requests from the back-end part of the transaction processing unit to the front-end part, which in response to receiving this enquiry forwards said financial transaction request to the back-end part, and
effectuating the financial transaction request by means of the back-end part of the transaction processing unit.

Communication between the back-end and the front-end part is in a preferred embodiment for safety reasons only possible when the back-end part initiates the communication (pulls data) from the front-end part, which is the part in open communication with a multitude of other units via the public communication network and therefore is more susceptible to intrusion.

In particular, the financial transaction request may be prepared based on said approved payment request as well as said payment verification corresponding thereto.

The method may further comprise the step of forwarding an approvement announcement to the electronic seller's unit upon approvement of the payment transaction. Additionally or alternatively, the method may comprise the step of forwarding an effecting announcement to the electronic seller's unit upon effectuation of the financial transaction.

It is preferred that the electronic buyer's unit and said electronic seller's unit are separate physical entities. However, it is also possible that the two functions may be performed by one physical unit, e.g. arranged in the shop of the seller, as long as the process is conducted as a two-factor payment transaction processing according to the description above and the appended claims.

It is preferred that the electronic buyer's unit is a handheld unit, such as a mobile phone, a mobile laptop computer, a Personal Digital Assistant (PDA) or the like comprising a wireless data communication arrangement by means of which the unit connects to a public wireless communication network as part of the data communication network connecting the electronic buyer's unit to the transaction processing unit.

The handheld unit may comprise a dedicated computer program product loaded into memory means of the handheld unit for controlling the communication between the handheld unit and the transaction unit.

The electronic buyer's unit may further be equipped with near-field wireless communication means, such as an RFID unit, for communicating a buyer's identification data to the electronic seller's unit so as to enable creation of the payment request.

It is preferred that the payment verification is forwarded in encrypted form from the electronic buyer's unit to the transaction processing unit.

In particular, the step of forwarding the payment verification may be followed by the step of forwarding a new private encryption key encrypted with a public key corresponding to a private encryption key stored in the electronic buyer's unit from the transaction processing unit to the electronic buyer's unit, where the new private encryption key is decrypted by means of the stored private encryption key and is stored for being used for the encryption of the next payment verification.

It is furthermore preferred that the method comprises the steps of
establishing said data communication connection between the electronic seller's unit and the transaction processing unit, the data communication connection comprising a public data communication connection, and
establishing said data communication connection between the electronic buyer's unit and the transaction processing unit, the data communication connection comprising a public data communication connection.

The present invention also relates to a transaction processing unit which is enabled to perform the method as described above and in the appended claims by means of data communication with one or more buyer's units and seller's units, said buyer's units and seller's units being external to the transaction processing unit.

The invention is particularly, but not exclusively, advantageous for obtaining a trusted identification of an individual before performing a related action.

An aspect of the present invention relates to a method of performing a transaction using a system comprising a point-of-sales device, a buyer device and a transaction device, the point-of-sales device adapted to communicate with the transaction device via a communication network, the buyer device is adapted to communicate with the transaction device via a communication network, the method comprising the steps of establishing a first transaction request at the point-of-sales device, the first transaction request comprising first buyer-identification information identifying a buyer related to the transaction, the first transaction request further comprising identification of the seller related to the transaction, the first request further comprising an amount to be paid, transmitting the first transaction request from the point-of-sales device to the transaction device via the communication network, transmitting from the transaction device to the buyer device a first payment verification request in response to receiving the first transaction request, and transmitting a first payment verification response from the buyer device to the transaction device.

By requesting verification that the transaction request actually originates from the user of the buyer device the security of the system is heightened and the risk of fraud is reduced. The first buyer-identification information may for instance be a user name, a user id number, a telephone number, an IMSI number or any other kind of information used for uniquely identifying an individual.

The point-of-sales device is in the present context construed as covering a seller's unit, an E-business unit, a physical store 6 as described in the present description.

Advantageously the system may further comprise a payment verification unit, and the method may further comprise the steps of establishing a second payment verification request comprising second buyer-identification information relating to the first buyer-identification information, transmitting the second payment verification request to the payment verification unit, and the payment verification unit establishing a payment verification response comprising payment acceptance or payment rejection information. The second buyer-identification information may for instance be an account number, a costumer number, a credit card number or another suitable information uniquely identifying wherefrom funds are to be transferred from so that a financial transaction may be performed.

Advantageously the method may comprise the payment verification response being transmitted from the payment verification unit to the transaction device, and the payment verification response being transmitted to the buyer device. By distributing the payment verification response to the transaction device and the buyer device both the buyer and the seller are notified of the approval or rejection of the payment.

Advantageously the transaction device comprises a front-end unit, the front-end unit handles communication regarding the first transaction request, the first payment verification request and the first payment verification response. Having a single unit handling one type of communication heightens the security of the system.

Advantageously the transaction unit comprises a back-end unit handling communication regarding the payment verification request and the payment verification response.

Advantageously by having both a front-end unit and a back-end unit the communication is completely separated and security is heightened.

Advantageously the communication between point-of-sales device and transaction device is encrypted and/or the communication between buyer device and transaction device is encrypted. By adding encryption to the communication between the devices security is heightened and the possibility for third parties to intrude or eavesdrop on the communication. Encryption may be implemented by using VPN or other suitable technology.

Advantageously the buyer device polls the transaction device for a first payment verification request before the first payment verification request is transmitted to the buyer device. Instead of pushing the first payment verification request to the buyer device the user needs to actively investigate if a first payment verification request is pending in the system, this reduces the amount of communication in the system.

Advantageously the transaction system comprises a database relating the first buyer-identification information to the second buyer-identification information. If the payment verification unit receives the first buyer-identification information the payment verification unit receives may not be able to correctly identify where to transfer the money from, therefore it is advantageous that the system comprises a database relating the two identification information's.

Advantageously the point of sales unit is at a physical store or the point of sales unit may be a unit in an electronic sales system, a web-shop, a part of an e-business, a physical device at a physical store or any combination hereof. As the method may securely and reliably establish identity of a person it would be advantageous to implement the method in a system for conducting commerce, including retail and B2B.

Advantageously the payment verification unit comprises information from or communicates with or is a part of a bank, a credit card company, a phone operator or other suitable financial institution.

An aspect of the present invention relates to a transaction system comprising a point-of-sales device, a buyer device, and a transaction device, the point-of-sales device adapted to communicate with the transaction device via a communication network, the buyer device adapted to communicate with the transaction device via a communication network, the point-of-sales device adapted for establishing a first transaction request, the first transaction request comprising first buyer-identification information identifying a buyer related to the transaction, the first transaction request further comprising identification of the seller related to the transaction, the first request further comprising an amount to be paid, the point-of-sales device adapted to transmit the first transaction request to the transaction device via the communication network, the transaction device adapted to transmit to the buyer device a first payment verification request in response to receiving the first transaction request, and the buyer device adapted to transmit a first payment verification response to the transaction device.

Generally the methods described in the present specification establishes the identity of a person in a secure and reliable way and thus it is advantageous to implement the method in a system for conducting financial transactions after establishing the identity of the user or buyer.

The buyer device mentioned may be a mobile device, a mobile or cell phone, a PDA, a portable computer device, a tablet pc, a desktop computer, a payment device located in a sales area.

The communication between the devices may be performed using the same communication network or similar type of networks.

Advantageously the system may further comprise a payment verification unit, and the transaction unit may be adapted to establish a second payment verification request comprising second buyer-identification information relating to the first buyer-identification information, and the transaction unit further adapted to transmit the second payment verification request to the payment verification unit, and the payment verification unit may be adapted to establish a payment verification response comprising payment acceptance or payment rejection information.

Advantageously the system may be further adapted to perform any of the steps mentioned in the relation to the methods relating to the present invention.

An aspect of the present invention relates to a method of authenticating identity of an individual and performing a related action, the individual having a portable electronic device including identification information and a portable electronic device communication device, the portable electronic device adapted to communicate with an authentication device comprising identification information relating to authorised individuals, the method comprising the authentication device generating an identification request for identification of the individual, the portable electronic device requesting reception of the identification request from the authentication device, transmitting the identification request from the authentication device to the portable electronic device, generating an identification response and transmitting the identification response from the portable electronic device to the authentication device, the authentication device receiving the identification response and relating the identification information in the identification response to the identification information relating to authorised individuals, establishing if the user is an authorised individual, provided the user is an authorised individual performing a related action. Generally the method provides a secure and reliable method of establishing the identity of a person and the established identity may then be used for performing one or more of a number of actions requiring that the established identity of the person can be trusted. Such actions includes providing physical access to a restricted area, providing electronic access to a computer system, performing a fiscal transaction, providing additional personal information relating to the individual and the additional personal information comprising passport information, drivers license information, membership information, subscription information, subscription status or a combination hereof.

The portable electronic device may be of a similar type mentioned elsewhere as the buyer's device.

The above aspects of the invention is particularly, but not exclusively, advantageous in that the present invention may be accomplished by a computer program product enabling a computer system to carry out the operations of the apparatus of the present invention when down- or uploaded into the computer system. Such a computer program product may be provided on any kind of computer readable medium, or through a network.

The individual aspects of the present invention may each be combined with any features of the other aspects. These and other aspects of the invention will be apparent from the following description with reference to the described embodiments.

### BRIEF DESCRIPTION OF THE FIGURES

The systems and methods according to the present invention will now be described in more detail with regard to the accompanying figures. The figures illustrates one way of implementing the present invention and is not to be construed as being limiting.

FIG. 1 schematically illustrates components of a transaction system according to the present invention,

FIG. 2 schematically illustrates an example of communication between elements of the transaction system,

FIG. 3 schematically illustrate dataflow in an e-business embodiment,

FIG. 4 schematically illustrate dataflow in an embodiment employing a handheld unit,

FIG. 5 schematically illustrate steps of a first run or configuration process, and

FIG. 6 schematically illustrate steps of an embodiment of a payment process,

FIG. 7 is a schematic block-diagram illustrating steps of a method according to the present invention,

FIG. 8 is a schematic block-diagram illustrating steps of a method according to the present invention,

FIG. 9 is a schematic system-chart representing an out-line of a system according to the present invention, and

FIG. 10 is a schematic block-diagram illustrating steps of a method according to the present invention.

### DETAILED DESCRIPTION OF AN EMBODIMENT

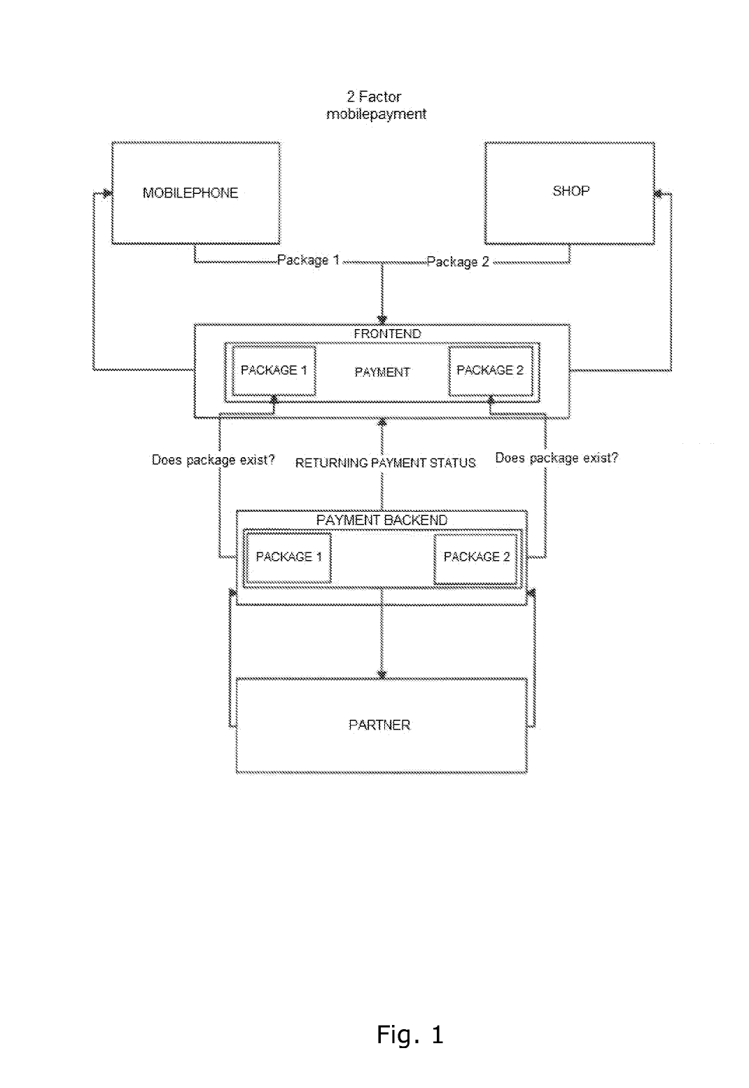

FIG. 1, “2 Factor mobile payment” illustrates the components of the transaction system according to an embodiment of the present invention,

The transaction system is a 2-factor payment solution. Payment is completed by the 2 factors: shop and the user handheld unit. Payments can only be completed if the user has a handheld unit physically in hand.

A payment is completed by the following:
1. Shop
   a. User creates an order inside a shop
   b. Shop sends information about the order to MSPay frontend
   c. An order is Package 2
2. Mobile phone
   a. User own a handheld unit where MSPay is installed
   b. By using MSPay software the user can retrieve information about a payment from frontend
   c. The user can accept or deny payments retrieved by the handheld unit
   d. User sends information about accepting or denying payments to the frontend
   e. Information send to frontend is Package 1
3. Frontend
   a. Frontend creates object “Payment” based on the information received from the shop
      i. If user do not exist in MSPay system callback is performed to shop and object Payment cannot be completed
   b. Frontend awaits both Package 1 and Package 2 until action is performed
   c. When both Packages exists inside object Payment the Payment is prepared to be finalized
      i. If Package 1 is a deny of payment frontend send callback to both shop and handheld unit and terminates the payment
   d. When payment is completed by backend frontend sends callback to both Shop and Mobile phone
4. Backend
   a. Backend constantly listens for prepared Payment objects
   b. Prepared Payment objects are fulfilled through partners
   c. When Payment are completed callback is made to Frontend
5. Partners
   a. Partner are completing payments
   b. Backend sends payment into partners where payments are completed
   c. Partner sends callback to Backend about Payment status

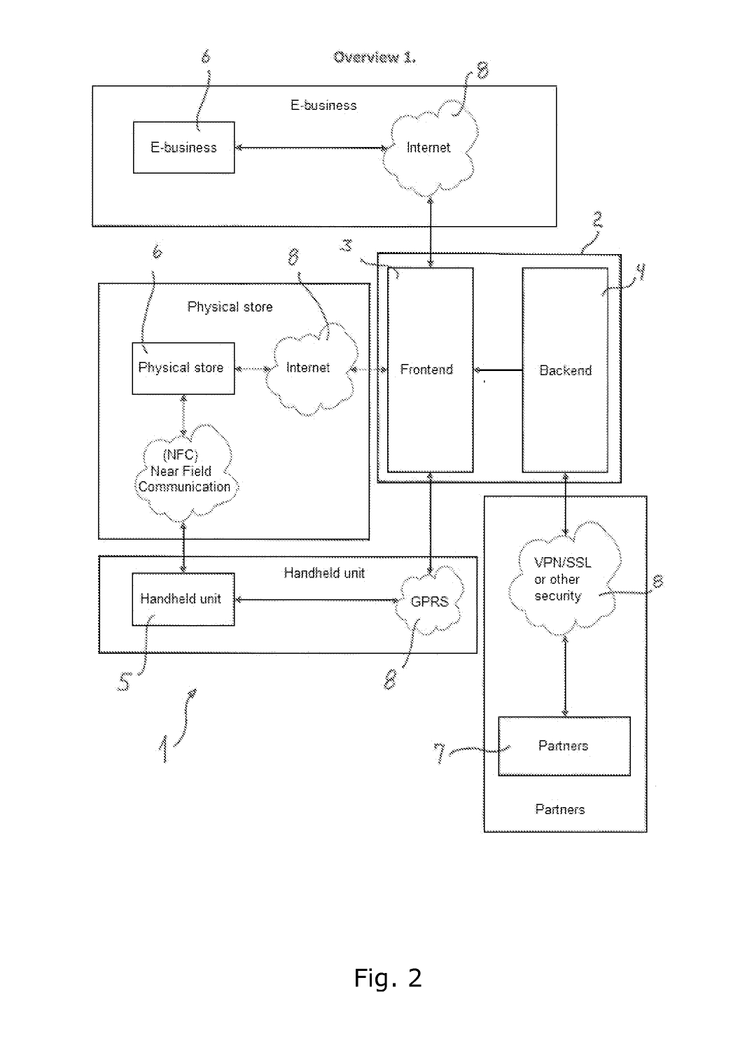

FIG. 2 “MSPay by MS Communication, Overview 1” illustrates an example of communication between elements of the transaction system.

MSPay comprises of the following subsystems:
1. System core
   a. Frontend
   b. Backend
2. Handheld unit
3. E-business
4. Physical store
5. Partners

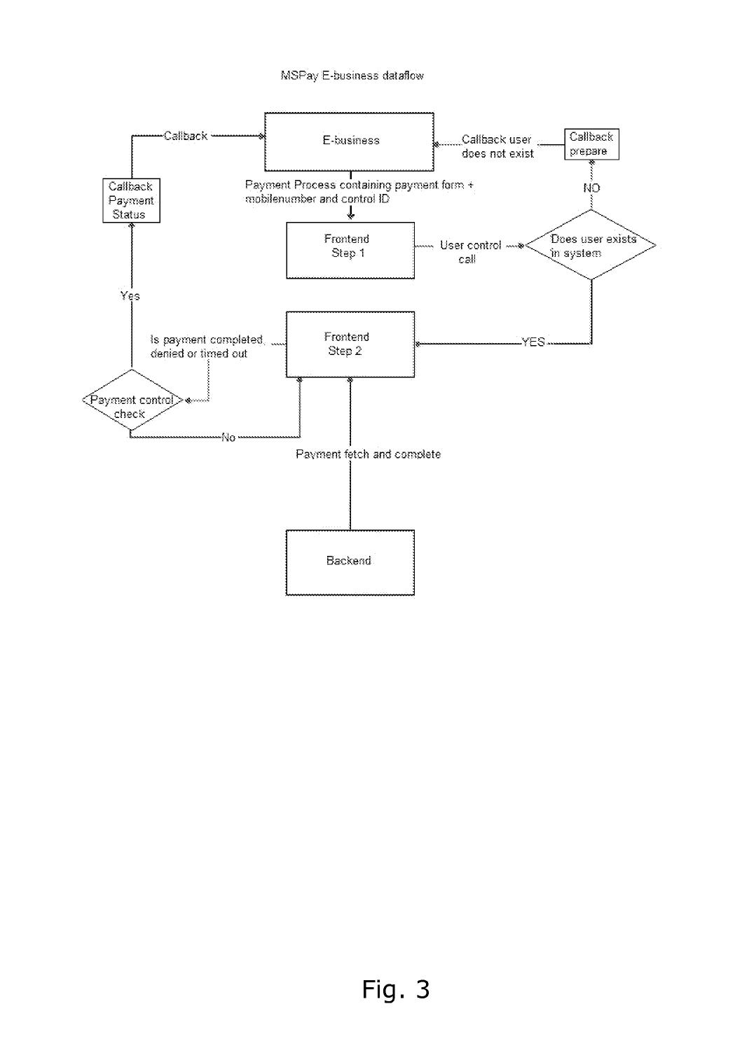

FIG. 3 “MSPay E-business dataflow”,

E-business comprises the following steps according to an embodiment of method:
1. E-business sends information about an order to frontend
   a. If user does not exist in MSPay system callback is made to E-business
2. Payment is created in frontend
3. Frontend awaits completion of payment and callback from backend
4. When payment is completed callback is made to E-business

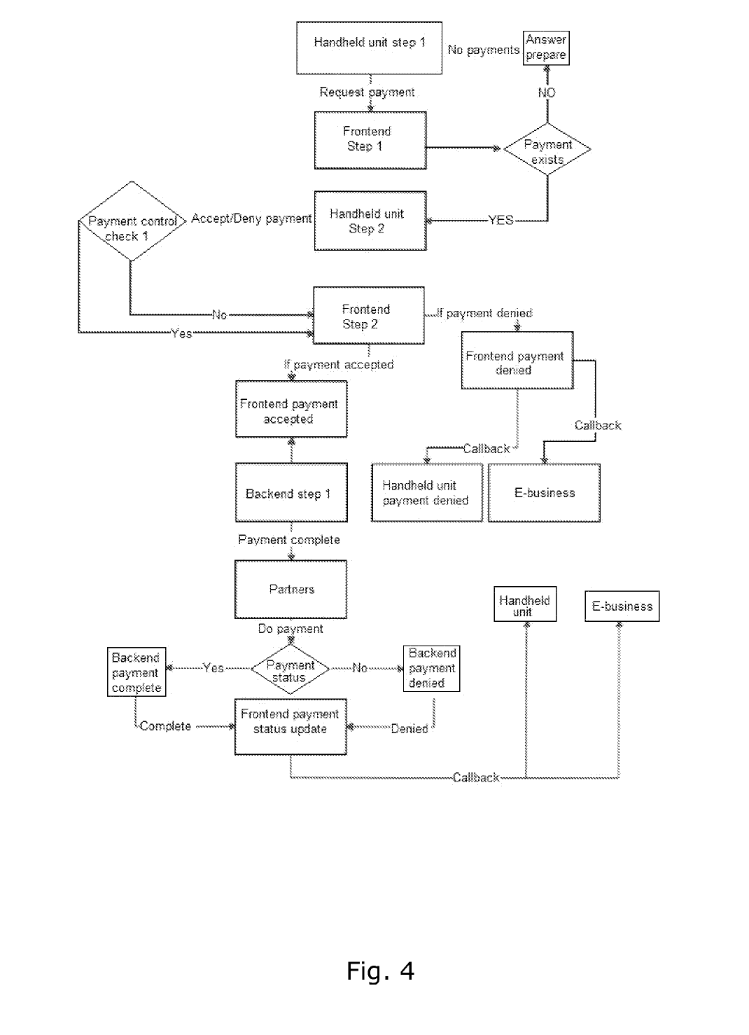

FIG. 4 “MSPay handheld unit”,

In this embodiment use of a handheld unit (buyer's unit) comprises the following steps:
1. User opens MSPay program on handheld unit
2. User request payment
   a. If no payments exist callback is made to MSPay program
   b. MSPay program terminate connection
3. Information about payment is show to user on MSPay program
4. User can deny/decline Payment
   a. If user declines payment callbacks are made by frontend to E-business and to user
   b. MSPay program terminate connection
5. User accepts payment
6. Payment is prepared in frontend completed by backend through partners and callback is send to user and to E-business
7. MSPay program terminate connection

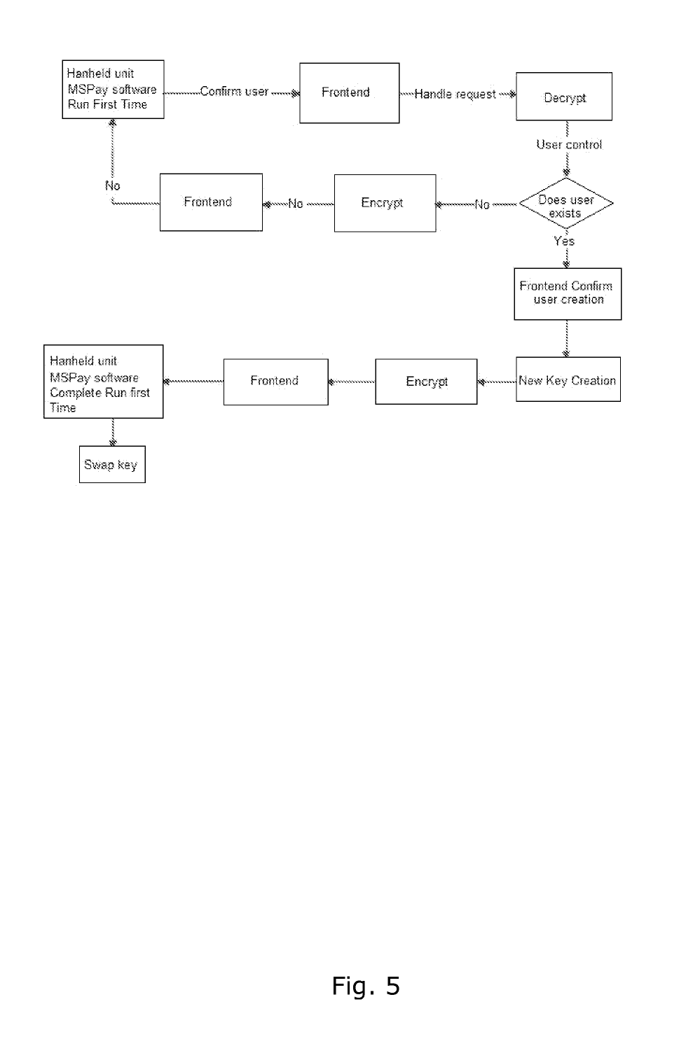

FIG. 5 “MSPay key exchange first run”

When a user runs MSPay first time user finalize user creation with the following steps
1. User types input fields comprising users mobile phone, users onetime pin, and users self selected password
2. Handheld unit prepares request to frontend which is encrypted with the onetime pin as key
3. Frontend receives request and decrypt it
4. A user control is made to ensure that user exists in system
   a. If user does not exists frontend informs user that user does not exist and terminate connection
5. If user exist frontend creates new key and prepares callback to handheld unit
6. Handheld unit receives reply that user creation is finalized
7. Handheld unit perform key swap and terminate connection

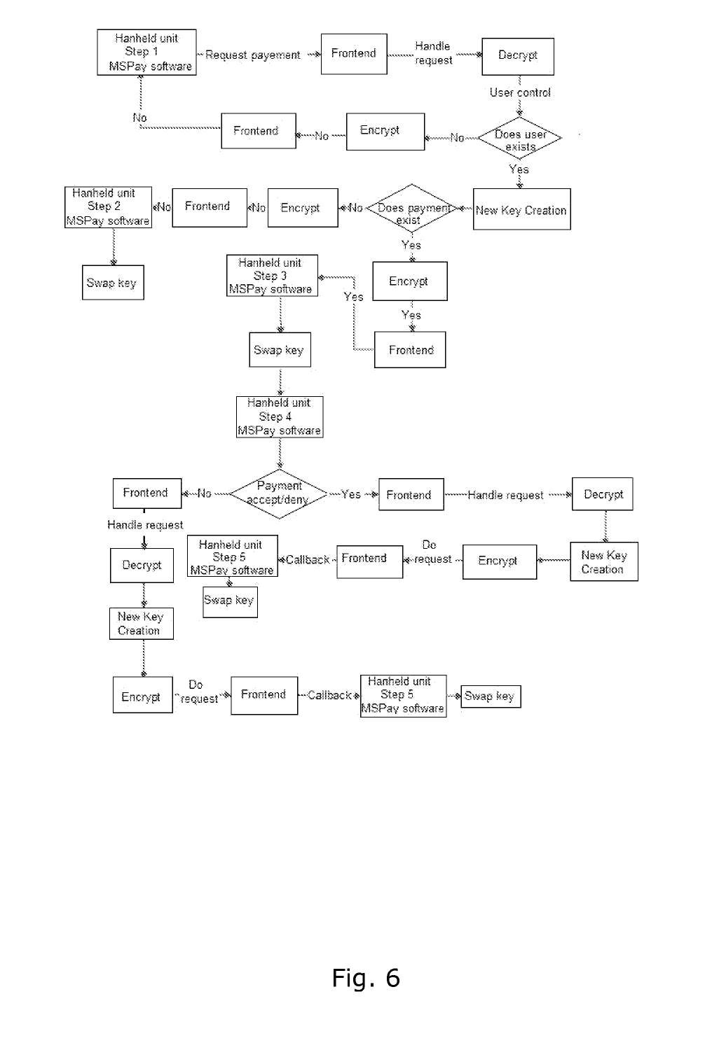

FIG. 6 “MSPay key exchange payment”

MSPay key exhanged comprises the following steps:
1. User requests a payment through MSPay software
2. Request is send to MSPay frontend
3. Frontend decrypts the request
4. A user control is performed to ensure the user exists in system
   a. If user does not exists frontend informs user that user does not exist and terminate connection
5. If user exist a new onetime key is generated
6. Frontend perform a control weather a payment exists for the user
   a. If no payment exist reply to user is encrypted and send to users handheld unit
   b. Mobile program swap keys and terminate connection
   c. New key will be used for encryption on next request
7. Information about payment is created and encrypted and send to mobile unit
8. Mobile unit perform a key swap
9. User accepts or denies payment on mobile unit through MSPay
   a. If user denies payment the reply to frontend is encrypted and send to frontend
   b. Frontend handles request and creates new key
   c. Confirmation about denied payment is send to handheld unit
d. Handheld unit swap key and terminate connection
10. Replay with confirmation that payment is accepted is send to frontend
11. Frontend handles reply and creates new key
12. Frontend awaits backend and when confirmation from backend arrives frontend send callback to handheld unit
13. Handheld unit perform key swap and terminate connection

The invention may be implemented by means of hardware, software, firmware or any combination of these. The invention or some of the features thereof can also be implemented as software running on one or more data processors and/or digital signal processors.

FIGS. 1 and 2 illustrate elements for implementation a presently preferred embodiment of the transaction arrangement 1. These elements are a buyer's unit 5, a seller's unit 6 and a transaction unit 2 which includes a front-end part 3 and a back-end 4 part. The seller's unit 6, illustrated as the E-business 6 and the physical store 6 are construed as the point-of sales unit mentioned in the present description.

Firstly the buyer needs to perform an initial registration as user of the transaction arrangement 1 and through this registration chose a partner 7 for carrying out the transfer of money from the buyer's account to the seller's account. Alternatively, the registration is performed through a partner 7, such as a bank or a credit card company, who is accepted already by the transaction arrangement 1.

The initial registration includes providing buyer identification data to the transaction unit 2 which, by the transaction unit 2, later on is used to identify the buyer in communication between the elements of the transaction arrangement 1. Such buyer identification is referred to as first buyer identification data and could e.g. be mobile telephone number or other data referring to the buyer's unit 5, address of the buyer, etc.

When a partner 7 has accepted that a buyer can use the transaction arrangement 1 for purchasing items from a shop, the transaction unit 2 provides to the buyer an access to download a software application and generates a buyer specific onetime PIN (Personal Identification Number) which is also provide to the buyer by safe communication, e.g. by paper mail.

When the software application is installed on the buyer's unit 5, which in this example could be a mobile telephone or any other handheld unit, the buyer's unit 5 needs to be registered by the transaction unit 2. The registration may be done by accessing the software application on the buyer's unit 5 and entering the onetime PIN. This is used to encrypt the request before being transmitted to the transaction unit 2.

In the transaction unit 2 the front-end 3 is able to decrypt the request for registration because of knowledge of the onetime PIN. If the buyer's unit is recognized by the transaction unit 2, a first unique key is created which together with information that the registration of the buyer was successfully completed is encrypted, based on the onetime PIN, and transmitted to the buyer's unit 5.

The software application at the buyer's unit 5 is capable of decrypting the response from the transaction unit 2 because of knowledge of the onetime PIN and the software performs a key swap so that the onetime PIN is replaced with the first unique key. Now both the buyer's unit 5 and the transaction unit 2 have knowledge of the first unique key enabling use of the first unique key for encrypting the next communication between the buyer's unit 5 and the transaction unit 2.

Different types of well-known encryption systems may be employed by the present system with symmetric or asymmetric keys.

Like the buyer, the seller also needs to be registered to be able to provide the opportunity for the seller's customers to use the transaction arrangement 1 when purchasing in the shop. The registration of the seller may be done very simple by the seller providing seller identification data to the transaction unit 2 or through partners 7 who is accepted already by the transaction arrangement 1.

When a buyer contacts a shop with the purpose of buying an item using the transaction arrangement 1, the buyer identifies himself to the shop, e.g. by means of accessing a homepage belonging to the seller and entering the data and hereby providing first buyer identification data to the shop. The shop holds item identification data, identifying items for sale in the shop and seller identification data, which is used to identify the shop in the transaction arrangement 1.

Alternatively, the buyer visits a physical shop and communicates the first buyer identification data orally or by a RFID chip or other near-field communication means from e.g. the mobile unit being the buyer's unit 5 to the seller's unit 6.

By using the seller's unit 6 the shop communicates with the transaction unit 1 and creates a payment request which is transmitted to the front-end 3. The payment request includes item identification data, identifying the item which the buyer wants to buy, first buyer identification data and seller identification data. When the payment request is safely received by the front-end 3, the transaction unit 2 informs the buyer, through the buyer's unit 5, that a payment request is awaiting acceptance before it can be further processed. It is preferred that the transaction unit 2 only informs the buyer's unit 5 after receipt of an enquiry from the buyer's unit 5 for payment requests, i.e. that the buyer's unit 5 pulls the payment requests instead of letting the transaction unit 2 push the payment requests to the buyer's unit, whereby the risk of erroneous payment of payment requests is reduced.

If the transaction unit 2 cannot identify a buyer from the first buyer identification data comprised in the payment request, the shop is notified and the payment request may be deleted from the transaction unit 2.

By using the buyer's unit 5, and the software application installed hereon, the buyer is capable of communicating with the transaction unit 2 and thereby capable of retrieving information relating to payment requests awaiting acceptance in the front-end 3. Such information could e.g. be price of an item, seller identification data, shipping costs, etc or simply an opportunity to accept a purchase of an amount from as seller. The transmission unit 2 knows to which buyer's unit 5 a payment request is to be transmitted because of the first buyer identification data comprised in the payment request from the seller's unit 6.

If the buyer refuses to accept the payment request, a payment refusal request is transmitted from the buyer's unit 5 to the front-end 3 of the transaction unit 2 and the shop and buyer is informed. The shop and buyer is also informed if the buyer does not answer the payment request within a given period of time. Actions taken by the transaction arrangement 1 in this situation may be configured to comply with individual requirements from the shops included in the transaction arrangement 1 or e.g. a default configuration such as saving or deleting the payment request.

If the buyer accepts the payment request a payment verification request, including second buyer identification, is transmitted from the buyer's unit 5 to the front-end 3. The second buyer identification may either be comprised within the data comprising the payment verification request or may be the payment verification request itself in an encrypted form, where the encryption itself or the key on which the encryption has been made is the second buyer identification.

The transaction unit 2 then needs to verify that the first buyer identification data included in the payment request and the second buyer identification data included in relation to the payment verification request identifies the same buyer, before the actual payment transaction between buyer and seller is executed.

This verification may be done in different ways depending on in which form the first and second buyer identification is received by the transaction unit 2. If the first and second buyer identification is both e.g. the telephone number of the buyer's unit 5, a correlation of the data of the payment request and of the payment verification request may be sufficient to verify that the identity of the buyer initiating a purchase is the same as the buyer operating the buyer's unit 5.

However, it is preferred for reducing the risk of intrusion into the transaction system that the first buyer identification data and the second buyer identification data are different and only may be correlated by means of data safely stored and accessible by the transaction unit and that the first buyer identification data and the second buyer identification data are not transmitted together in the communication between the buyer's unit and the transaction unit 2 or between the seller's unit 6 and the transaction unit 2. Preferably, the first buyer identification data is never transmitted from the buyer's unit 5, at least not by means of the same communication means as is used to communicate with the transaction unit 2. Hereby, an interception of the communication between the units, 2, 5, 6 of the system will not or only with great difficulty are usable for misuse of the transaction system.

If either the payment request or the payment verification request is encrypted the payment request and/or the payment verification request may need to be decrypted to perform the correlation to verify the identity of the buyer.

Alternatively, if e.g. the payment verification request is encrypted and maybe encrypted by a special or predetermined method, the fact that the payment verification request is encrypted may be interpreted as the second buyer identification.

Furthermore if a key, e.g. as explained above, are needed to encrypt and decrypt e.g. the payment verification request, that key may be interpreted as the second buyer identification. This may also be the case even if the key are changed each time data is transmitted or received either from the buyer's unit 5 or from the transaction unit 2.

One example of using a key for encrypting e.g. the payment verification request is described in the following. This example could start as describe above where the buyer receives a onetime PIN, which after the first communication between the buyer's unit 5 and the transaction unit 2 is swapped with a first unique key.

After this registration procedure the buyer is ready to use the transaction arrangement 1 for purchasing. When a buyer e.g. in an internet shop has initiated the purchase of an item, the Internet shop prepares a payment request and forward this to the front-end 3. Then the buyer, through the software application installed on the buyer's unit 5, requesting the front-end 3 to forward any non-verified payment requests. This request is encrypted, by the software application installed on the buyer's unit 5, with the first unique key.

It is preferred that the buyer contacts the transaction unit 2 to obtain information of non-verified payment request. This minimizes the risk that the buyer unintentionally verifies a payment request e.g. believing he answered a text message.

Because the transaction unit 2 created the first unique key, the transaction unit 2 is able to decrypt the request from the buyer's unit 5. If the buyer is registered by the transaction unit 2, the transaction unit 2 generates a second unique key and checks if there are any non-verified payment requests to that specific buyer.

At least part of the information, from the non-verified payment request, necessary for the buyer to determine whether or not to verify the payment request is, together with the second unique key encrypted based on the first unique key and send to the buyer's unit 5. This data communication is also referred to as payment verification request.

The software application installed on the buyer's unit 5 receives the encrypted information from the transaction unit 2, decrypts the information and swaps the first unique key with the second unique key. Hence the second unique key is then known by both the transaction unit 2 and the buyer's unit 5 and ready for use to encrypt/decrypt the next data communication between the transaction unit 2 and the buyer's unit 5.

The next data communication may be a verification of the payment request from the buyer. This verification is encrypted with the second unique key and transmitted to the transaction unit 2. The transaction unit 2 then decrypts the verification and creates a third unique key. When the payment is verified and ready to be effectuated, the payment is on request form the back-end 4 communicated to the back-end 4 where it, by the partners 7, is effectuated.

When the payment for the purchase is effectuated this information is together with the third unique key encrypted based on the second unique key and transmitted to the buyer's unit 5. The software application installed on the buyer's unit 5 is then decrypting the received data to gain access to the information transmitted by the transaction unit 2. The decrypting is made based on knowledge of the second unique key and after decrypting, the second unique key is swapped with the third unique key, which is then ready or use in encrypting/decrypting the next transmission between the transaction unit 2 and the buyer's unit 5.

In the above example of encrypting data communication between the transaction unit 2 and the buyer's unit 5, the encrypting of the data communication itself may be regarded as the second buyer identification.

It should be noted that it may not be necessary to encrypt all of the data communications between the transaction unit 2 and the buyer's unit 5, but encrypting is of course preferred since it increases security and thereby preventing fraud.

If the verification is not approved, both the buyer and the seller are informed and may e.g. be asked to create a new payment request and payment verification request.

If the verification is approved the actual payment transaction between buyer and seller is ready to be executed.

The payment transaction is taken care of by the back-end 4, which is continuously asking the front-end 3 for any approved payment transaction.

All information regarding the transaction of money between buyer and seller is only accessible via the back-end 3. Hence to improve safety communication between the front-end 3 and the back-end 4 is always initiated by a request from the back-end 4, it is therefore not possible to access trusted and confidential information guarded by the back-end 4 from a request from the front-end 3.

The back-end 4 communicates via secure data communication such as e.g. VPN and SSL with one or more partners 7. A partner 7 may e.g. be a bank, telephone company, provider and account administrator of credit cards, etc. where the buyer has an account.

Hence a payment transaction is executed when the back-end 4 contacts a bank with information of the approved payment transaction, the bank then transfers the amount of money stated in the approved payment transaction from the buyers account to the sellers account and notifies the back-end 4 of the status of the transaction. Further both the buyer and the seller is informed by the transaction unit 1 of the status of the transaction.

Using a bank for transferring money is, as indicated above, only an example. The buyer enters, during the initial subscription as user of the transaction arrangement 1, which financial institution he wishes to take care of the payment transactions on his behalf.

When referring to the seller reference is made to a shop, whether it is a virtual shop e.g. accessed through the internet or a physical shop e.g. located in a shopping center is of no importance for the transaction arrangement 1. This is because when using the transaction arrangement 1 the need of credit cards are eliminated and thereby also the risk of fraud linked with the trusted information printed thereon in case the credit card is lost.

The seller identification data could e.g. comprise identification of items for sale such as size, price, shipping costs, information of physical or virtual location of the seller, etc.

The data communication may be based almost all wired or wireless data communication technologies. FIG. 1 illustrates some of the preferred data communication networks 8 and protocols including the internet, TCP/IP, VPN (VPN: Virtual Private Network), GPRS (GPRS: General Packet Radio Service), NFC (NFC: Near Field Communication), SSL (SSL: Secure Socket Layer) protocols.

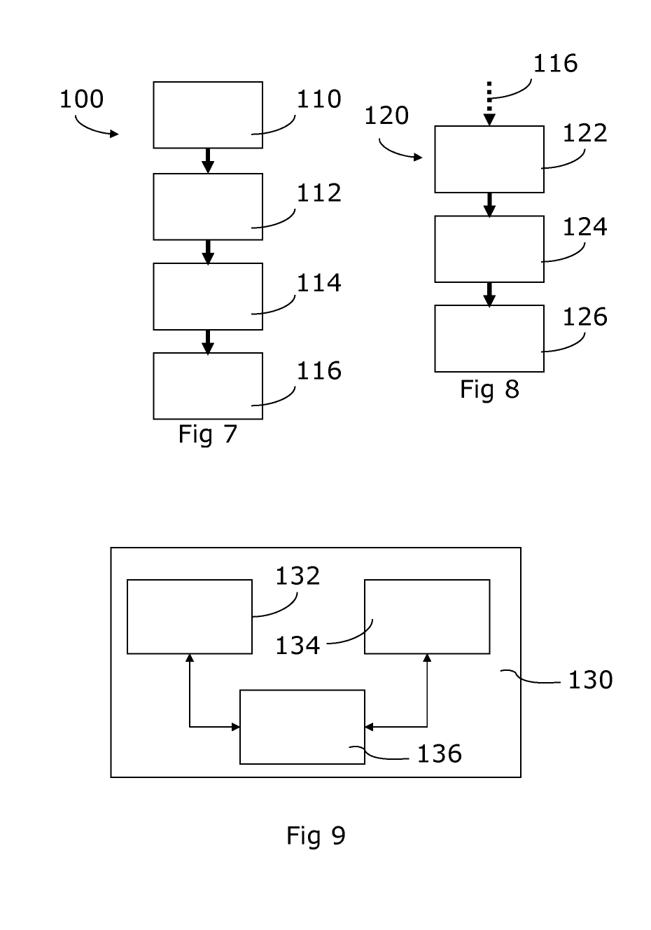

FIG. 7 schematically illustrate an embodiment of a method 100 of performing a transaction using a system comprising a point-of-sales device, a buyer device and a transaction device, the point-of-sales device adapted to communicate with the transaction device via a communication network, the buyer device adapted to communicate with the transaction device via a communication network. The method 100 comprises the step 110 of establishing a first transaction request at the point-of-sales device, the first transaction request comprising first buyer-identification information identifying a buyer related to the transaction, the first transaction request further comprising identification of the seller related to the transaction, the first request further comprising an amount to be paid. The method 100 comprises the step 112 of transmitting the first transaction request from the point-of-sales device to the transaction device via the communication network. The method 100 comprises the step 114 of transmitting from the transaction device to the buyer device a first payment verification request in response to receiving the first transaction request. The method 100 comprises the step 116 of transmitting a first payment verification response from the buyer device to the transaction device.

Advantageously the method 100 may be implemented as software and performed using a system such as that illustrated in FIG. 9. The method 100 may be modified to include any features mentioned throughout the present description.

FIG. 8 schematically illustrate an embodiment of a method 120 comprising the steps 110 to 116 illustrated in FIG. 7, illustrated by the punctured line 116, and additional steps 122, 124 and 126 described below. Compared to the system performing the method 100 the system in this embodiment further comprises a payment verification unit. The method 120 comprises the step 122 establishing a second payment verification request comprising second buyer-identification information relating to the first buyer-identification information. The method 120 comprises the step 124 transmitting the second payment verification request to the payment verification unit. The method 120 comprises the step 126 the payment verification unit establishing a payment verification response comprising payment acceptance or payment rejection information.

FIG. 9 schematically illustrates a transaction system 130 comprising a point-of-sales device 132, a buyer device 134, and transaction device 136. The point-of-sales device 132 is adapted to communicate with the transaction device 136 via a communication network 138. The buyer device 134 is adapted to communicate with the transaction device 136 via a communication network 140. The point-of-sales device 132 is adapted for establishing a first transaction request, the first transaction request comprising first buyer-identification information identifying a buyer related to the transaction, the first transaction request further comprising identification of the seller related to the transaction, the first request further comprising an amount to be paid. The point-of-sales device 132 is adapted to transmit the first transaction request to the transaction device 136 via the communication network 138. The transaction device 136 is adapted to transmit to the buyer device 132 a first payment verification request in response to receiving the first transaction request. The buyer device 132 adapted to transmit a first payment verification response to the transaction device 136. The communication network 138 and 140 may be the same or similar networks, e.g. a data communications network, including the internet, data communication over wireless communications protocols, mobile internet, WiFi ect as also mentioned elsewhere in the present description.

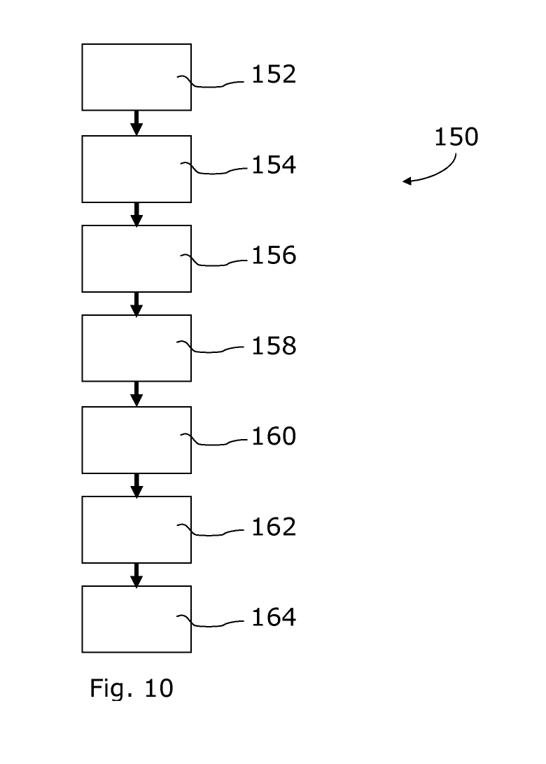

FIG. 10 schematically illustrates a method 150 of authenticating identity of an individual and performing a related action. The individual has a portable electronic device including identification information and a portable electronic device communication device, the portable electronic device is adapted to communicate with an authentication device comprising identification information relating to authorised individuals. The method 150 comprising the step 152 of the authentication device generating an identification request for identification of the individual. The method 150 comprising the step 154 of the portable electronic device requesting reception of the identification request from the authentication device. The method 150 comprising the step 156 of transmitting the identification request from the authentication device to the portable electronic device. The method 150 comprising the step 158 of generating an identification response and transmitting the identification response from the portable electronic device to the authentication device. The method 150 comprising the step 160 of the authentication device receiving the identification response and relating the identification information in the identification response to the identification information relating to authorised individuals. The method 150 comprising the step 162 of establishing if the user is an authorised individual, provided the user is an authorised individual performing 164 a related action.

The steps in the methods described above are not listed in specific sequences that are mandatory to be followed.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

Although the present invention has been described in connection with the specified embodiments, it should not be construed as being in any way limited to the presented examples. Elements or features of the different embodiments could be combined. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

Further the present invention may be characterised by the following points:

1. Method for processing a payment transaction between a buyer and a seller by means of a transaction arrangement including a transaction processing unit, an electronic seller's unit connected to the transaction processing unit via a data communication network, and an electronic buyer's unit connected to the transaction processing unit via a data communication network, the method comprising the steps of:
receiving a payment request from the electronic seller's unit to the transaction processing unit, the payment request comprising at least seller identification data and buyer identification data,
preparing a payment verification request based on said payment request by means of the transaction processing unit,
forwarding the payment verification request from the transaction processing unit to the electronic buyer's unit,
receiving a payment verification from the electronic buyer's unit to the transaction processing unit, and
approving the payment transaction when said payment request as well as said payment verification corresponding thereto have been received by the transaction processing unit.

2. Method according to point 1, wherein the payment request comprises first buyer identification data and the payment verification comprises second buyer identification data being different from the first buyer identification data, and wherein approvement of the payment transaction further requires that it has been confirmed that the first buyer identification data are correctly correlated with the second buyer identification data.

3. Method according to point 1 or 2, wherein the transaction processing unit forwards the payment verification request to a specific electronic buyer's unit corresponding to the first buyer identification data.

4. Method according to any of the preceding points, further comprising the step of forwarding a enquiry for payment verification requests from the electronic buyer's unit to the transaction processing unit, which in response to receiving this enquiry forwards said payment verification request to the electronic buyer's unit.

5. Method according to any of the preceding points, comprising the step of
establishing a data communication connection between a computer system and the seller's unit, and
forwarding the buyer identification data for being applied in the payment request to the seller's unit.

6. Method according to any of the preceding points, wherein the transaction processing unit comprises a front-end part which via the data transmission networks is connected to the electronic seller's unit and to the electronic buyer's unit, and a back end part which via a data transmission network is connected to external providers of financial transaction, the method comprising the steps of
preparing a financial transaction request in response to the approvement of the payment transaction by means of the front-end part of the transaction processing unit,
forwarding a enquiry for financial transaction requests from the back-end part of the transaction processing unit to the front-end part, which in response to receiving this enquiry forwards said financial transaction request to the back-end part, and
effectuating the financial transaction request by means of the back-end part of the transaction processing unit.

7. Method according to point 6, wherein the financial transaction request is prepared based on said approved payment request as well as said payment verification corresponding thereto.

8. Method according to any of the preceding points, further comprising the step of forwarding an approvement announcement to the electronic seller's unit upon approvement of the payment transaction.

9. Method according to any of the preceding points, further comprising the step of forwarding an effecting announcement to the electronic seller's unit upon effectuation of the financial transaction.

10. Method according to any of the preceding points, wherein said electronic buyer's unit and said electronic seller's unit are separate physical entities.

11. Method according to any of the preceding points, wherein the electronic buyer's unit is a handheld unit comprising a wireless data communication arrangement by means of which the unit connects to a public wireless communication network as part of the data communication network connecting the electronic buyer's unit to the transaction processing unit.

12. Method according to point 11, wherein the handheld unit comprises a dedicated computer program product loaded into memory means of the handheld unit for controlling the communication between the handheld unit and the transaction unit 2.

13. Method according to point 11 or 12, wherein the electronic buyer's unit further comprises with near-field wireless communication means, such as an RFID unit, for communicating a buyer's identification data to the electronic seller's unit so as to enable creation of the payment request.

14. Method according to any of the preceding points, wherein the payment verification is forwarded in encrypted form from the electronic buyer's unit to the transaction processing unit.

15. Method according to point 14, wherein the step of forwarding the payment verification is followed by the step of forwarding a new private encryption key encrypted with a public key corresponding to a private encryption key stored in the electronic buyer's unit from the transaction processing unit to the electronic buyer's unit, where the new private encryption key is decrypted by means of the stored private encryption key and is stored for being used for the encryption of the next payment verification.

16. Method according to any of the preceding points, further comprising the steps of
establishing said data communication connection between the electronic seller's unit and the transaction processing unit, the data communication connection comprising a public data communication connection, and
establishing said data communication connection between the electronic buyer's unit and the transaction processing unit, the data communication connection comprising a public data communication connection.

17. A transaction processing unit which is enabled to perform the method according to any of the preceding points by means of communication with one or more buyer's units and seller's units, said buyer's units and seller's units being external to the transaction processing unit.

18. A method of performing a transaction using a system comprising a point-of-sales device, a buyer device and a transaction device, the point-of-sales device adapted to communicate with the transaction device via a communication network, the buyer device adapted to communicate with the transaction device via a communication network, the method comprising:
establishing a first transaction request at the point-of-sales device, the first transaction request comprising first buyer-identification information identifying a buyer related to the transaction, the first transaction request further comprising identification of the seller related to the transaction, the first request further comprising an amount to be paid,
transmitting the first transaction request from the point-of-sales device to the transaction device via the communication network,
transmitting from the transaction device to the buyer device a first payment verification request in response to receiving the first transaction request, and
transmitting a first payment verification response from the buyer device to the transaction device.

19. The method according to point 18, wherein the system further comprises a payment verification unit and the method further comprises:
establishing a second payment verification request comprising second buyer-identification information relating to the first buyer-identification information, and
transmitting the second payment verification request to the payment verification unit, wherein the payment verification unit establishes a payment verification response comprising payment acceptance or payment rejection information.

20. The method according to point 19, wherein the payment verification response is transmitted from the payment verification unit to the transaction device, and the payment verification response is transmitted to the buyer device.

21. The method according to any of the point 18, wherein the transaction device comprises a front-end unit that handles communication regarding the first transaction request, the first payment verification request and the first payment verification response.

22. The method according to point 19, wherein the transaction unit comprises a back-end unit that handles communication regarding the payment verification request and the payment verification response.

23. The method according to point 18, wherein the communication between the point-of-sales device and the transaction device is encrypted and/or the communication between the buyer device and the transaction device is encrypted.

24. The method according to point 18, wherein the buyer device polls the transaction device for a first payment verification request before the first payment verification request is transmitted to the buyer device.

25. The method according to point 18, wherein the transaction system comprises a database relating the first buyer-identification information to the second buyer-identification information.

26. The method according to point 18, wherein the point of sales unit is at a physical store or wherein the point of sales unit is a unit in an electronic sales system, a web-shop, a part of an e-business, or a physical device at a physical store or any combination thereof.

27. The method according to point 19, wherein the payment verification unit comprises information from or communicates with or is a part of a bank, a credit card company, a phone operator or a financial institution.

28. A transaction system comprising:
a point-of-sales device,
a buyer device, and
a transaction device, wherein:
   the point-of-sales device is adapted to communicate with the transaction device via a communication network,
   the buyer device is adapted to communicate with the transaction device via a communication network,
   the point-of-sales device is adapted for establishing a first transaction request that comprises first buyer-identification information identifying a buyer related to the transaction and identification of the seller related to the transaction, wherein the first transaction request further comprises an amount to be paid,
   the point-of-sales device is further adapted to transmit the first transaction request to the transaction device via the communication network,
   the transaction device is adapted to transmit to the buyer device a first payment verification request in response to receiving the first transaction request, and
   the buyer device is adapted to transmit a first payment verification response to the transaction device.

29. The transaction system according to point 28, further comprising a payment verification unit, wherein:
the transaction unit is adapted to establish a second payment verification request comprising second buyer-identification information relating to the first buyer-identification information, and the transaction unit is further adapted to transmit the second payment verification request to the payment verification unit, and
the payment verification unit is adapted to establish a payment verification response comprising payment acceptance or payment rejection information.

30. The transaction system according to point 28, wherein the system is further adapted to transmit the payment verification response from the payment verification unit to the transaction device and transmit the payment verification response to the buyer device.

1. A method of authenticating the identity of an individual and performing a related action, the individual having a portable electronic device including identification information and a portable electronic device communication device, wherein the portable electronic device is adapted to communicate with an authentication device comprising identification information relating to authorized individuals, the method comprising:
the authentication device generating an identification request for identification of the individual,
the portable electronic device requesting reception of the identification request from the authentication device,
transmitting the identification request from the authentication device to the portable electronic device,
generating an identification response and transmitting the identification response from the portable electronic device to the authentication device, the authentication device receiving the identification response and relating
the identification information in the identification response to the identification information relating to authorized individuals, and
establishing if the user is an authorized individual, provided the user is an authorized individual performing a related action.

2. The method according to claim 1, wherein the related action includes providing physical access to a restricted area, providing electronic access to a computer system, performing a fiscal transaction, providing additional personal information relating to the individual and the additional personal information comprising passport information, drivers license information, membership information, subscription information, or subscription status or any combination thereof.
